(19) United States
(12) Patent Application Publication
(10) Pub. No.: US 2007/0137368 A1
(43) Pub. Date: Jun. 21, 2007

(54) TWO-POSITION LOCKING DEVICE FOR A SUPPORT FIXTURE

(76) Inventors: Joseph P. DeVille, Lisbon, OH (US); Robert W. Potter, Rochester Hills, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/562,696

(22) Filed: Nov. 22, 2006

Related U.S. Application Data
(60) Provisional application No. 60/739,070, filed on Nov. 22, 2005.

(51) Int. Cl. G05G 11/00

(52) U.S. Cl. 74/483 K

(57) ABSTRACT

A support fixture supports a plurality of components on a shipping rack. The support fixture includes a frame, a plurality of fingers and a locking device. Each finger is pivotally coupled to the frame for movement about a pivot between a support position and a released position. Each finger has a front end and a back end extending from substantially opposite sides of a pivot wherein the front end is presented for supporting one of the components in the support position. The fingers are arranged in a stack with a first finger being disposed at an end of the stack. Each of the fingers has a boss that extends outwardly therefrom to hold an adjacent finger in the support position. The locking device has a pin that is axially movable between an extended position disposed along the back end of the first finger to hold the first finger in the support position and a retracted position spaced apart spaced apart from the first finger to allow pivotal movement of the first finger between the support and released positions. The locking device also has a button operatively coupled to the pin to cause alternating actuation of the pin between the extended and retracted positions with each push of the button toward the pin.

### REFERENCE TO RELATED APPLICATION

This application claims priority to U.S. Provisional Patent Application Ser. No. 60/739,070, filed Nov. 22, 2005, the entire content of which is incorporated herein by reference.

### FIELD OF THE INVENTION

The invention relates to a two-position locking device that allows selective locking of a support fixture used to support a plurality of parts on a shipping rack.

### BACKGROUND OF THE INVENTION

In the production of complex assemblies, such as automotive vehicles, it is common to utilize a shipping rack for transporting parts between a manufacturing or assembly plants. Some parts may be stacked on top of each other in an overlying manner on a shipping rack and delivered to a plant. Other parts, such as body panels, cannot be stacked in this manner and must be maintained spaced apart to prevent dents or scratching due to contact with adjacent parts. These parts may be made of sheet metal or fiberglass and are, therefore, subject to damage in shipping if they are bent, scratched or cracked. To avoid damage, the parts must be carefully packed, secured for shipping, and carefully removed for use in the assembly plant. At some assembly plants, robotic equipment is used to remove the parts from the shipping rack for use in production. It remains desirable to provide a shipping rack that securely locks parts thereto for safe transport between plants and further facilitates the use of robotic equipment in the removal of the parts from the shipping rack.

### SUMMARY OF THE INVENTION

According to one aspect of the invention, a support fixture is provided for supporting a plurality of components on a shipping rack. The support fixture includes a frame, a plurality of fingers and a locking device. Each finger is pivotally coupled to the frame for movement about a pivot between a support position and a released position. Each finger has a front end and a back end extending from substantially opposite sides of a pivot wherein the front end is presented for supporting one of the components in the support position. The fingers are arranged in a stack with a first finger being disposed at an end of the stack. Each of the fingers has a boss that extends outwardly therefrom to hold an adjacent finger in the support position. The locking device has a pin that is axially movable between an extended position disposed along the back end of the first finger to hold the first finger in the support position and a retracted position spaced apart spaced apart from the first finger to allow pivotal movement of the first finger between the support and released positions. The locking device also has a button operatively coupled to the pin to cause alternating actuation of the pin between the extended and retracted positions with each push of the button toward the pin. The button extends outwardly from the frame and moves axially with the pin during movement between the extended and retracted positions to facilitate external visual identification of the position of the pin.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a side elevational view of a locking device according to a first embodiment of the invention indicating extended (solid lines) and retracted (dotted lines) positions;

FIG. 2 is an exploded top perspective view of the locking device in FIG. 1;

FIG. 3A is an exploded bottom perspective view of the locking device in FIG. 1;

FIG. 3B is a bottom perspective view of the locking device of FIG. 1, which has been cutaway to show the internal components thereof;

FIG. 4 is a top perspective view of a support fixture according to another embodiment of the invention utilizing the locking device;

FIG. 5 is a top perspective view of a plurality of support fixtures, as shown in FIG. 4, mounted to a rack for supporting a plurality of panels in transport;

FIG. 6 is an enlarged perspective view of an upper portion of the support fixture cutaway to show the locking engagement between the locking device and a top-most finger;

FIG. 7 is a top perspective view of the locking device according to a second embodiment of the invention, which has been cutaway to show the internal components thereof; and

FIG. 8 is an exploded top perspective view of the locking device of FIG. 7.

### DETAILED DESCRIPTION OF THE PREFERRED EMBODIMENTS

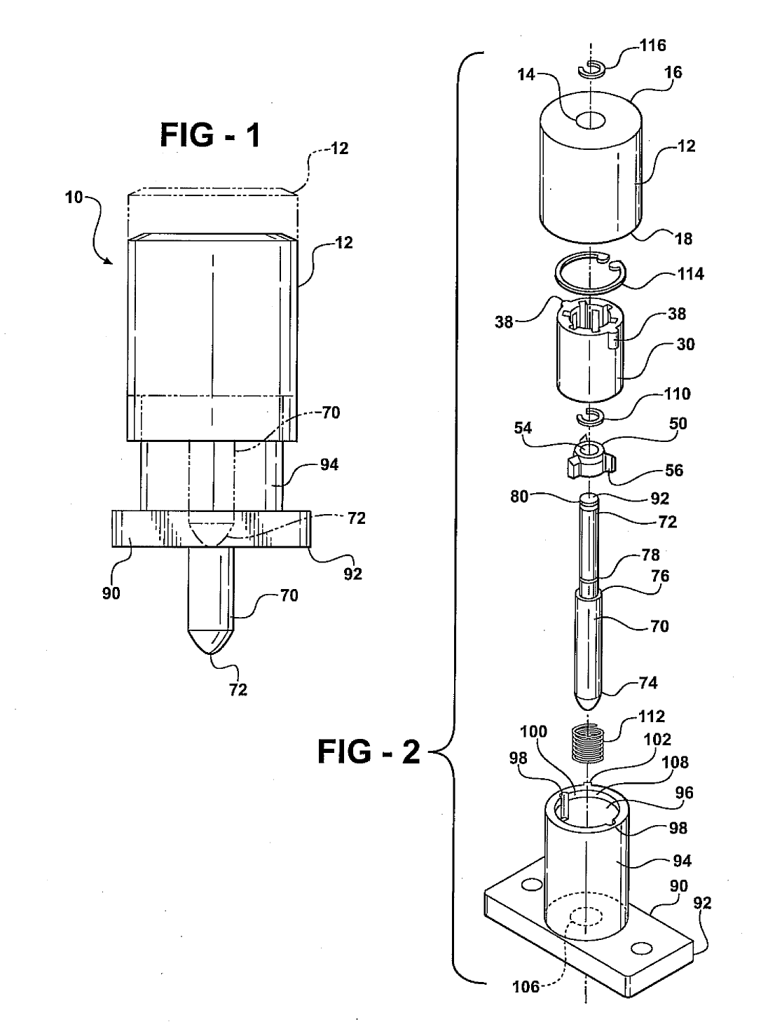

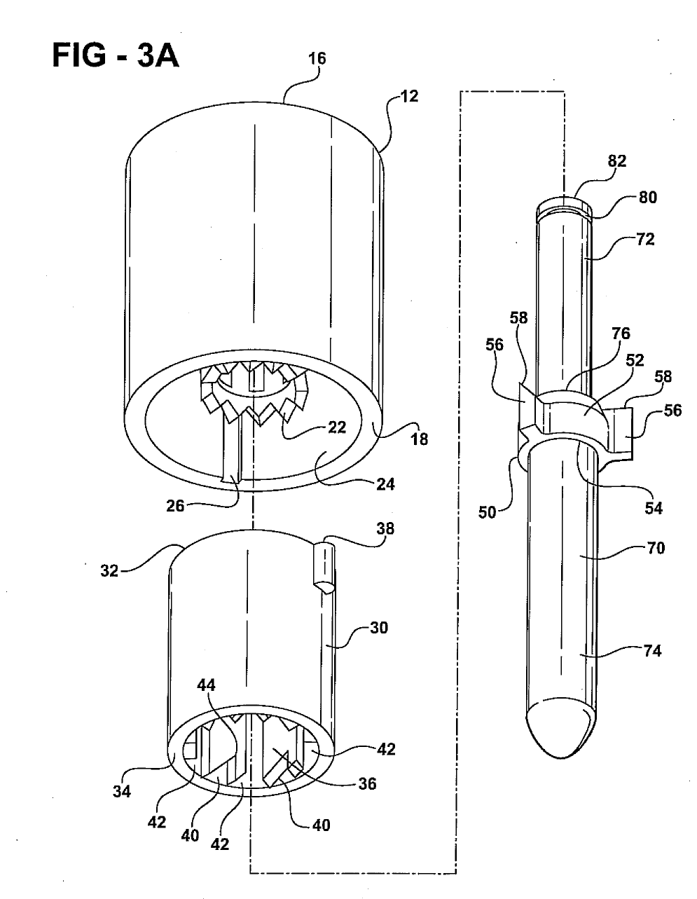

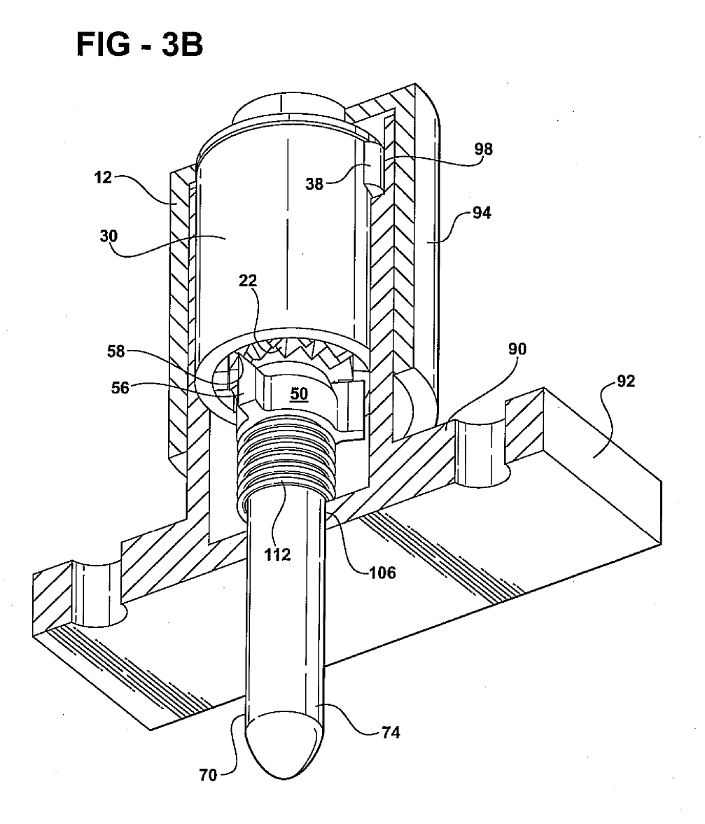

Referring to FIGS. 1-3, a locking device according to one embodiment of the invention is generally indicated at 10. The locking device 10 includes a button 12, a spline bushing 30, a spool 50, a pin 70 and a body 90.

The button 12 is cylindrically shaped and has a center bore 14 extending axially therethrough. The button 12 has an outer end 16 and an opposite inner end 18. A cylindrical inner cavity 20 is defined at the inner end 18 of the button 12. A plurality of teeth 22 are disposed in the inner cavity 20 and extend axially toward the inner end 18. The teeth 22 are arranged in a generally annular row and are radially spaced apart from an inner cavity wall 24. A longitudinally extending groove 26 is formed in the inner cavity wall 24. The groove 26 extends between the teeth 22 and through the inner end 18 of the button 12.

The spline bushing 30 is cylindrically shaped and extends between opposite outer 32 and inner 34 ends. A center bore 36 extends axially between the ends 32, 34 of the spline bushing 30. At least one rib 38 extends radially outwardly from an outer surface of the spline bushing 30. The spline bushing 30 includes a plurality of grooves 40, 42. A first set of grooves 40 is shorter than a second set of grooves 42. The grooves 40, 42 are arranged circumferentially along an inner surface of the spline bushing 30 in an alternating pattern. Each of the shorter grooves 40 is defined by a wedge-shaped cutout 44.

The spool 50 includes a cylindrical body 52 having a center bore 54. Arms 56 extend outwardly from the body 52 of the spool 50. Each arm 56 corresponds in shape with the shape of each cutout 44 defining the shorter grooves 40. Each arm 56 includes a cam surface 58 that is engageable with the teeth 22 to cause rotation of the spool 50 about the pin 70. The spool 4. 50 rotates about the pin 70 to engage the first 40 and second 42 set of grooves in an alternating manner with each actuation of the locking device 10.

The pin 70 is generally cylindrically shaped. The pin 70 includes a reduced diameter portion 72 and an engagement end 74. The reduced diameter portion 72 has a smaller diameter than the engagement end 74. A shoulder 76 is defined between the outer 72 and inner 74 ends due to their difference in diameter. An annular first slot 78 is formed on the reduced diameter portion 72. The first slot 78 is spaced apart from the shoulder 76 by a distance slightly larger than the height of the spool 50. An annular second slot 80 is formed adjacent an end 82 of the reduced diameter portion 72.

The body 90 includes a mounting portion 92 and a receiving portion 94. The mounting portion 92 and the receiving portion 94 are fixedly secured to or otherwise integrally formed to each other. The receiving portion 94 is cylindrically shaped and includes a cylindrical cavity 96 for receiving the spline bushing 30 therein. At least one axially extending slot 98 is formed along an inner cavity wall 100 for engaging the at least one rib 38 of the spline bushing 30. An outer rib 102 extends radially outwardly from an outer surface of the body 90 for engaging the groove 26 in the button 12. A bore 106 extends through the mounting portion 92 for receiving the pin 70 therethrough. An annular third slot 108 is formed in the inner cavity wall 100.

In assembly, the pin 70 extends through the center bores 14, 36, 54 and 106 of the button 12, spline bushing 30, spool 50 and body 90, respectively. The spool 50 rests against the shoulder 76. A first retainer or snap ring 110 is inserted into the first slot 78 to axially retain the spool 50 against the shoulder 76. The spool 50 remains, however, rotatably coupled to the pin 70. The engagement end 74 of the pin 70 extends through the bore 106 in the mounting portion 92 of the body 90. A biasing member 112 in the form of a helical spring is continuously compressed between the spool 50 and the mounting portion 92.

The rib 38 of the spline bushing 30 is inserted through the slot 98 in the inner cavity wall 100 of the body 90. A second snap ring 114 is fitted into the third slot 108 to axially maintain the spline bushing 30 within the cavity 96 of the body 90. Thus, the spline bushing 30 is rotatably and axially constrained relative to the body 90. The body 90 is received by the cavity 20 of the button 12. The outer rib 102 from the body 90 is slidably engaged with the groove 26 in the inner cavity wall 24 of the button 20. A third snap ring 116 is fitted into the second slot 80 for axially constraining the button 12 relative to the pin 70.

By this arrangement, the pin 70 is selectively movable between an extended position and a retracted position. In the extended position, as shown by the solid lines in FIG. 1, the engagement end 74 of the pin 70 protrudes from a bottom surface of the mounting portion 92. In the retracted position, as shown by the dotted lines in FIG. 1, the engagement end 74 of the pin 70 is substantially flush with the bottom surface of the mounting portion 92, or at least closer to the bottom surface Than in the extended position. Further, the button 12 moves with the pin 70 between the extended and retracted positions. That is, the button 12 and the mounting portion 92 are further spaced apart from each other in the retracted position than in the extended position.

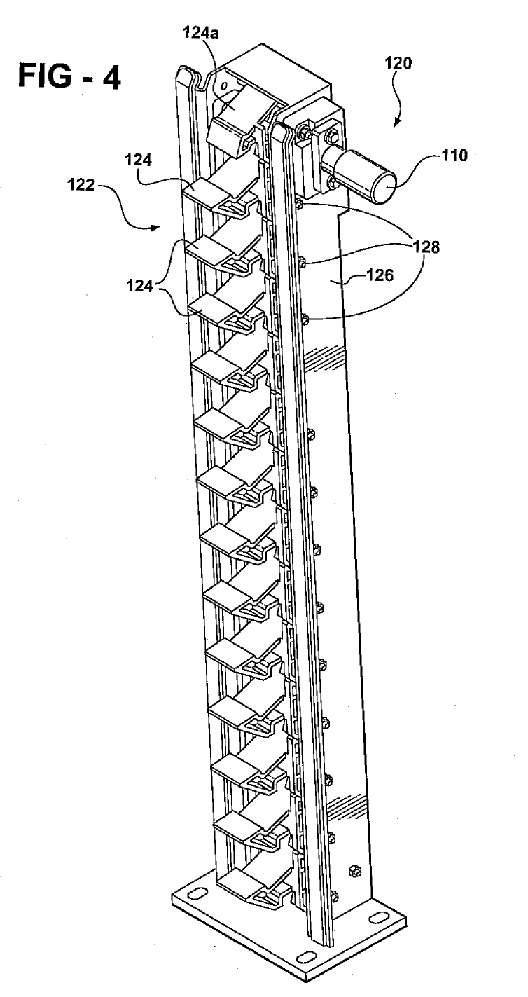

Referring to FIGS. 4-7, a support fixture 120 is shown for supporting a plurality of panels P. The support fixture 120 includes a retaining mechanism generally indicated at 122. The retaining mechanism 122 utilizes a plurality of fingers 124 each pivotally coupled to a frame 126 for movement about a pivot 128 between a support position for supporting a panel P and a released position generally orthogonal to the support position. In the illustrated embodiment, the support fixture 120 is configured to support the panels P in a vertically stack manner. Each finger 124 includes a front end 130 that extends outwardly from the pivot 128. In the support position, the front end 130 is generally horizontal to support a portion of a panel P. Each finger 124 also includes a back end 132 that extends outwardly from the pivot 128 substantially opposite from the front end 130. Each of the fingers 124 also includes a downwardly extending boss 134 that contacts an adjacent underlying finger in the support position. By this arrangement, all of the fingers 124 can be held in the support position by locking just the top-most finger 124a in the support position. The back end 132 is weighted to bias the finger 124 toward the release position. In one embodiment of the invention, the fingers 124 are made of a molded plastic material.

The locking device 10 is fixedly secured to the support fixture 120 by a threaded bolt 133 extending through the mounting portion 92 of the body 90 and the frame 126. The locking device 10 may be secured to the support fixture by other methods, such as welding, adhesives and the like. A hole 128 is formed in the frame 126 that allows the pin 70 to extend therethough to engage the back end 132 and thereby retain the top-most finger 124a in the extended position.

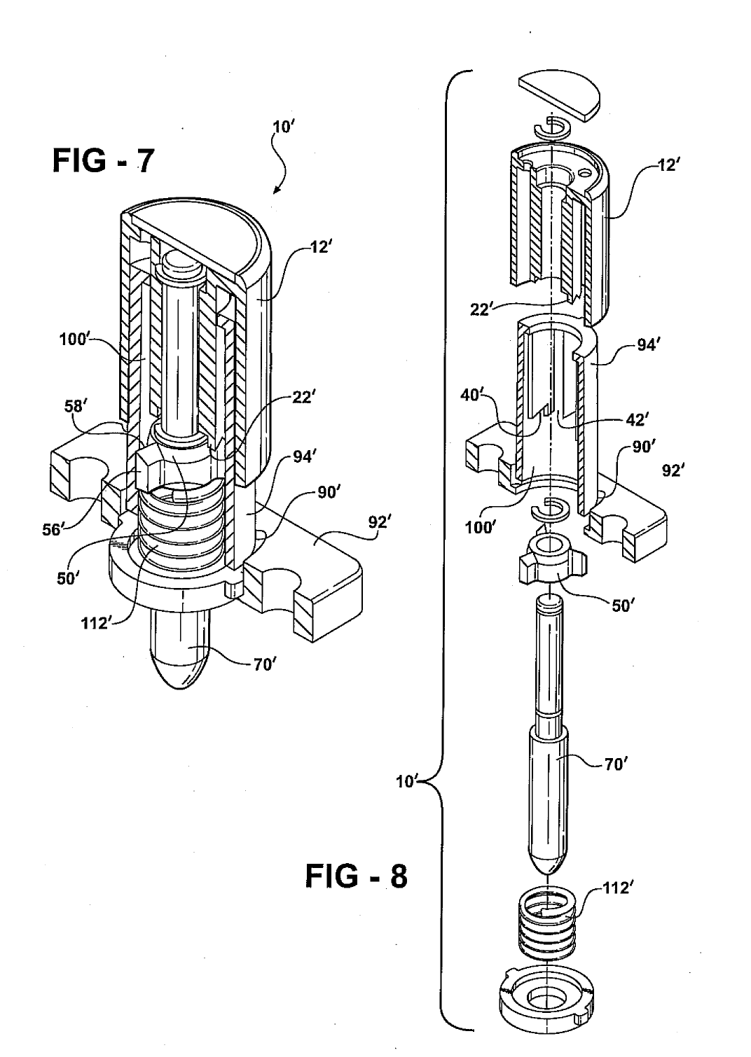

In use, a plurality of support fixtures 120 may be mounted to a rack R, as shown in FIG. 7. The rack R is used to securely support the panels P for transport between manufacturing facilities. For illustrative purposes, the operation of a single locking device and support fixture is described below.

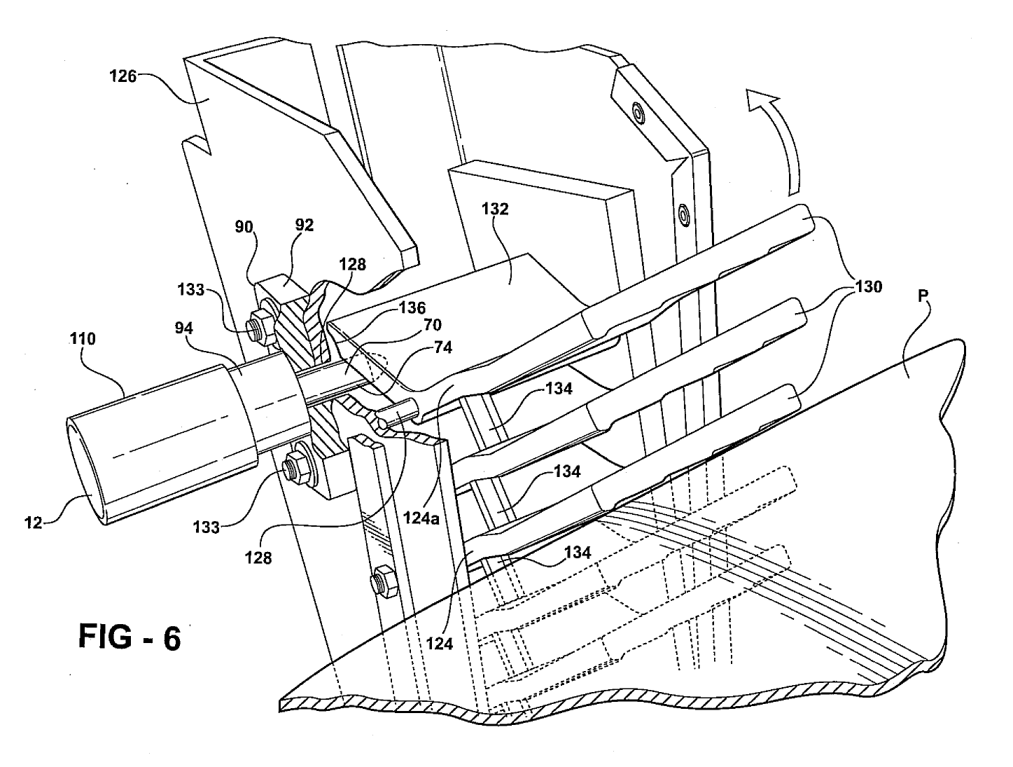

The operation is described beginning with the pin 70 in the retracted position and the fingers 124 in the released position. Referring to FIGS. 6 and 8, all of the fingers 124 are pivoted to the support position to allow an operator to place the panels P in a stack on the support fixture 120, where each panel P is supported between an adjacent pair of fingers 124. Each finger 124, with the exception of the top-most finger 124a, is maintained in the support position by the weight of each panel P and/or an adjacent finger above that is also in the support position.

In the retracted position, the arms 56 of the spool 50 are disposed within the deeper set of grooves 42 of the spline bushing 30. Further, the biasing member 112 continuously biases the pin 70 toward the retracted position. To move the pin 70 to the extended position, axial pressure is applied onto the button 12 toward the mounting portion 92. The teeth 22 of the button 12 engage the arms 56. The teeth 22 have angled surfaces that tend to cause rotation of the spool 50 about the pin 70. The spool 50 rotates “one position” such that the arms 56 are now axially aligned with the shorter grooves 40 of the spline bushing 30.

The button 12 is released, thereby allowing the biasing member 112 to move the arms 56 toward engagement with the shorter grooves 40. The pin 70 moves to the extended position due to the engagement of the arms 56 with the shorter grooves 40. As the pin 70 moves to the extended position, the engagement end 74 of the pin 70 protrudes below the back end 132 of the top-most finger 124a to prevent rotation of the top-most finger 124a in the direction of the arrow indicated in FIG. 8. A cam surface 136 is formed at the back end 132 of the top-most finger 124a. The cam surface 136 engages the engagement end 74 of the pin 70 to move the top-most finger 124a toward the support position in case the back end 132 is blocking the pin 70 as it moves to the extended position.

With the pin 70 in the extended position, the top-most finger 124a is locked in the support position. The remaining fingers 124 are also locked in the support position due to the locked in the support position by actuating the pin 70 to the extended position and locking the top-most finger 124a in the support position.

The top panel in the stack of panels P may be removed by first actuating the pin 70 to the retracted position. The pin 70 is returned to the retracted position by again axially pressing the button 12 toward the mounting portion 92. The teeth 22 cause the spool 50 to index to the next position, such that the arms 56 are axially aligned with the deeper set of grooves 42. The pressure on the button 12 is released to allow the biasing member 112 to move the arms 56 into the deeper grooves 42, which in turn allows the pin 70 to move to the retracted position. Thus, the position of the pin 70 alternates between the extended and retracted positions with each subsequent depression of the button 12 toward the mounting portion 92.

With the pin 70 now retracted, the top-most finger 124a is then movable from the support position to the release position, thereby allowing the panel P to be lifted from the adjacent finger 124 below. The adjacent finger 124 moves to the release position under the weighted bias of its back end 132, which allows the next panel P to be lifted therefrom. This is repeated for each finger 124 until all of the panels P have been removed from the future 120.

The locking device 10 may be actuated either manually by an operator or automatically by a robotic arm. The simple axial actuation of the button 12 facilitates automatic unlocking of the locking device with a robotic arm. For example, the arm may have an appendage or member that engages the button 12 as it is positioned to pickup the first panel P. Since the button 12 moves with the pin 70 between the extended and retracted positions, a position sensor, such as an optical sensor, may also be used to detect the position of the button 12 as an indication of the position of the pin 70, i.e. indicating whether the locking device is locked or unlocked. This information indicating the status of the locking device may then be used in a control system used to control the actions of the robotic arm.

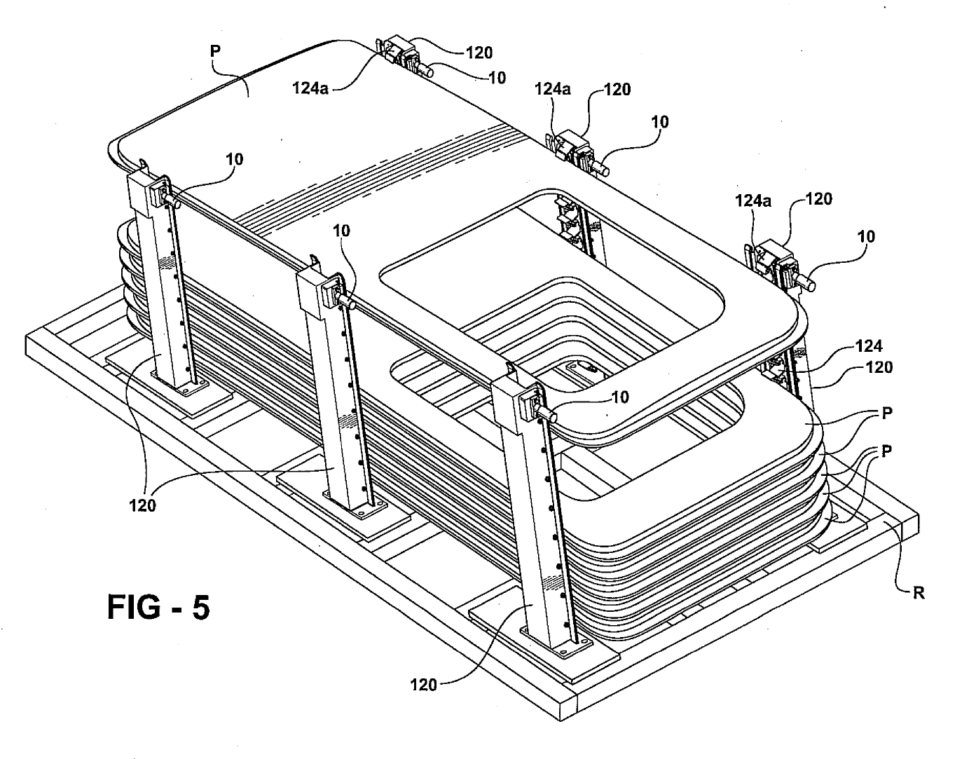

In FIGS. 4 and 5, a second embodiment of the locking device 10′ is shown, wherein the spline bushing is eliminated as a separate part and the grooves 40′, 42′ are formed along the inner surface 100′ of the receiving portion 94′ of the body 90′.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

1. A support fixture for supporting a plurality of components on a shipping rack, said support fixture comprising:
a frame;
a plurality of fingers each pivotally coupled to the frame for movement about a pivot between a support position and a released position, each finger having a front end and a back end extending from substantially opposite sides of a pivot wherein the front end is presented for supporting one of the components in the support position, the plurality of fingers being arranged in a stack with a first finger being disposed at an end of the stack, each of the plurality of fingers including a boss extending outwardly therefrom to hold an adjacent finger in the support position; and
a locking device having a pin that is axially movable between an extended position disposed along the back end of the first finger to hold the first finger in the support position and a retracted position spaced apart spaced apart from the first finger to allow pivotal movement of the first finger between the support and released positions, the locking device further having
a button operatively coupled to the pin to cause alternating actuation of the pin between the extended and retracted positions with each push of the button toward the pin, the button extending outwardly from the frame and moving axially with the pin during movement between the extended and retracted positions to facilitate external visual identification of the position of the pin.

2. A support frame as set forth in claim 1, wherein the locking device includes a mounting portion configured for fixedly securing the locking device to the frame of the support fixture.

3. A support frame as set forth in claim 2, wherein the mounting portion has opposite first and second surfaces, and having a hole extending through the first and second surfaces.

4. A support frame as set forth in claim 3, wherein the locking device includes a receiving portion that extends from the first surface of the mounting portion, the receiving portion having a generally cylindrically shaped cavity for receiving the pin therethrough.

5. A support frame as set forth in claim 4, wherein the cavity has an inner surface generally coaxially aligned with the hole in the mounting portion.

6. A support frame as set forth in claim 5, wherein the locking device includes a plurality of axially extending grooves formed along the inner surface of the receiving portion.

7. A support frame as set forth in claim 6, wherein a first set of the grooves are shorter than a second set of the grooves, the first and second grooves being arranged in an alternating manner about the inner surface.

8. A support frame as set forth in claim 7 including a spool that is axially constrained relative to the pin for movement therewith between the extended position and the retracted position, the spool having at least one arm that extends outwardly relative to the pin to engage the first set of grooves in the extended position and the second set of grooves in the retracted position.

9. A support frame as set forth in claim 8, wherein the spool is rotatable about the pin to allow engagement of the at least one arm with the first and second set of grooves in an alternating manner with each actuation of the locking device.

10. A support frame as set forth in claim 9 including a biasing member continuously biasing the spool in an axial direction toward the grooves, the biasing member being a helical coil spring.

11. A support frame as set forth in claim 10, wherein the button includes an annular row of teeth extending axially toward the spool, each tooth engaging a cam surface of the at least one arm of the spool when the button is pressed to rotate spool about the pin and cause engagement of the at least one arm with the first and second set of grooves in an alternating manner with each actuation of the locking device.

12. A support frame as set forth in claim 11, wherein the button includes an inner cavity wall spaced apart from the annular row of teeth to accept the receiving portion therein.

13. A support frame as set forth in claim 11, wherein the button and receiving portion are rotatably constrained by a tab and slot arrangement.

14. A support frame as set forth in claim 13, wherein the annular row of teeth extend through the generally cylindrical cavity of the receiving portion for engaging the spool.

15. A support frame as set forth in claim 8 wherein the pin includes a shoulder for axially locating the spool relative to the pin.

16. A support frame as set forth in claim 15 including a first retainer coupled to the pin to retain the spool against the shoulder and still allow rotation of the spool relative to the pin.

17. A support frame as set forth in claim 4 including a spline bushing disposed in the generally cylindrical cavity of the receiving portion, the spline bushing being rotatably constrained in the receiving portion by a tab and slot arrangement.

18. A support frame as set forth in claim 17, wherein the spline bushing includes a generally cylindrical inner surface coaxially aligned with the hole in the mounting portion.

19. A support frame as set forth in claim 18, wherein the spline bushing includes a plurality of axially extending grooves formed along the inner surface thereof, a first set of the grooves being shorter than a second set of the grooves, the first and second grooves being arranged in an alternating manner about the inner surface of the spline bushing.

20. A support frame as set forth in claim 19 including a spool that is axially constrained relative to the pin for movement therewith between the extended position and the retracted position, the spool having at least one arm that extends outwardly relative to the pin to engage the first set of grooves in the extended position and the second set of grooves in the retracted position, the spool being rotatable about the pin to allow engagement of the at least one arm with the first and second set of grooves in an alternating manner with each actuation of the locking device.

21. A support frame as set forth in claim 20 wherein the button includes an annular row of teeth extending axially toward the spool, each tooth engaging a cam surface of the at least one arm of the spool when the button is pressed to rotate spool about the pin and cause engagement of the at least one arm with the first and second set of grooves in an alternating manner with each actuation of the locking device.

22. A support frame as set forth in claim 1, wherein the first finger includes a cam surface formed along the back end thereof to move the first finger toward the support position as the pin moves from the retracted position toward the extended position.
